(19) United States
(12) Patent Application Publication
(10) Pub. No.: US 2007/0147681 A1
(43) Pub. Date: Jun. 28, 2007

(54) System and method for extracting a face from a camera picture for representation in an electronic system

(75) Inventor: Bartel Marinus Van De Sluis, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/579,874

(22) PCT Filed: Nov. 15, 2004
(86) PCT No.: PCT/IB04/52425

§ 371 Date: May 18, 2006

Related U.S. Application Data
(60) Provisional application No. 60/524,280, filed on Nov. 21, 2003.

(51) Int. Cl. G06K 9/46; G06K 9/34; G06K 9/00

(52) U.S. Cl. 382/190; 382/173; 382/118

(57) ABSTRACT

A system and method for representing a person in an electronic system. An image is obtained including an image of a target person. The image or a digital representation thereof, is processed to recognize a facial feature associated with the target person in the image. The target person's facial portion is then extracted from the image. The extracted target person's facial portion is displayed via a display interface associated with a same or separate and distinct electronic system to represent the target person when connected to that electronic system. An image capture device capturing the image obtained is adapted to take an image at a moment when a target person is smiling or when a target person is gazing towards capture device. An icon may be generated that includes the extracted target person's facial portion for representing the target user via a display interface associated with the electronic system.

The present invention relates generally to computer vision technology for recognizing images, and more particularly, to computer vision technology that extracts an image, such as a person's face, from a picture, for representation in an electronic system.

In present and future electronic systems, people are/will be able to meet each other online, in a so-called “virtual space” and, in order to identify themselves in this virtual space, they need to be represented by a personal icon. For example, a virtual space may be realized by any P2P system (e.g., global networking).

In another example, at the entrance of an office building a display could show a map of all rooms including pictures, i.e., iconic representations, of the persons who are currently in each room. The question arises how these kind of ‘person icons’ may be easily captured, and kept up-to-date.

Face recognition systems may be employed for determining faces in an image. A representative face recognition system is described in U.S. Pat. No. 6,108,437 which is directed to a feature extraction system that processes an image for determining whether a face is present in an image and for determining its position in the image. One application of a face recognition system is described in U.S. Pat. No. 5,781,650 which is directed to a system for determine facial features from an extracted image in order to classify a person's age from his/her image. U.S. Pat. No. 5,987,154 entitled “Method and Means for Detecting People in Image Sequences” is directed to a system for locating a person in a sequence of video images to facilitate visual communication. International Patent Publication WO-200310728 is another application of a face recognition system that is targeted at privacy safeguarding. Its aim is to hide identities of people/objects by first detecting the presence of a person's personal identifying characteristics present in an image, and then automatically removing or replacing those characteristics.

Most face recognition systems use computer vision for recognizing identity of people and objects and these systems do not output (arts of) the image itself. The reference WO-200310728 is the only exception to this, but here the goal is to hide the identity of a person.

The prior art computer vision systems are thus deficient in that none of these systems is used to capture and process an image of a person in order to use it to represent the person in another system, e.g., a PCC or, like system requiring interfacing of humans and machines. Thus, it would be highly desirable to provide a computer vision system that aims to present an image of a face as representation of a person's identity in an organization or system.

It is an object of the present invention to provide a computer vision system and methodology that presents an image of a face as representation of a person's identity in an organization or system. In accordance with this object, the computer vision system and method addresses the timing/selection of a desired image. For instance, an image may be selected in which the subject person is gazing at the camera, or in which the person is smiling, etc.

Accordingly, a computer vision system and methodology is provided that implements includes face recognition for capturing a picture of the person that needs to be represented in another electronic system that uses or presents images, for example, and to extract or ‘cut out’ the face from that picture. The system and method is further able to take the snapshot on the moment that the person is gazing straight towards the camera or even at the moment that a person's facial appearance is in a desired state, e.g., is smiling, and render the extracted image suitable for representation in another electronic system. Thus, the inventive system addresses the timing/selection of a desired image to be extracted.

Also provided are a computer program product for carrying out the methods of the present invention and a program storage device for the storage of the computer program product therein. The computer program product can be embodied in a computer-readable medium or contained in the multi-media stream.

These and other features, aspects, and advantages of the apparatus and methods of the present invention will become better understood with regard to the following description, appended claims, and accompanying drawings where:

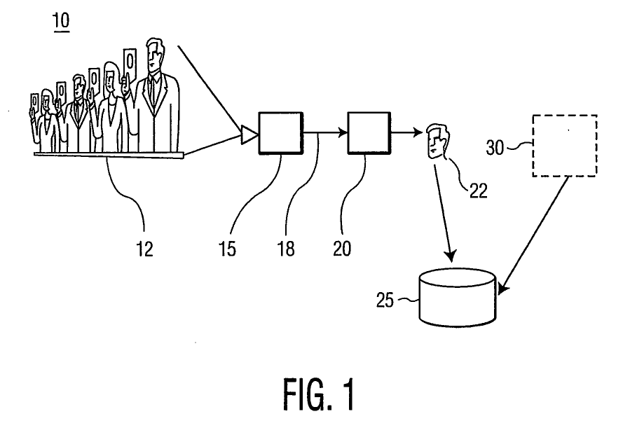

FIG. 1 illustrates a schematic view of an embodiment of an apparatus for detecting and extracting an image from a video camera output (digital stream);

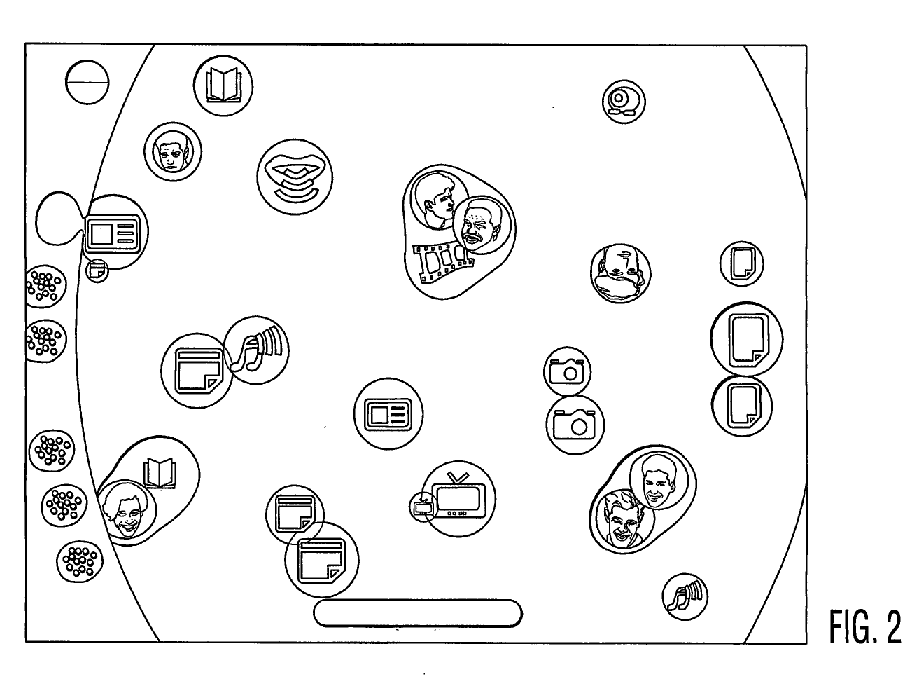

FIG. 2 illustrates one application for using an extracted portrait of a person for identifying that person as an icon in a personal content container device connectable via a WiFi network.

The most natural way of representing a person is by a picture of the person's face. However, it is hard for a person to position himself in front of a camera in such a way that the picture has the appropriate properties of a portrait photo. Referring now to FIG. 1, there is illustrated a schematic of an embodiment of an apparatus 10 for detecting a person in an image.

According to the invention, a first step is processing of an image to check for the presence of a face (using facial features). For example, as shown in FIG. 1, a camera device 15 adapted to generate still image or full-motion video images generates, respectively, a first real-world image 12 or series of images (an image sequence), e.g., of a person or group of people, for example. This image may be digitized and converted to a digital stream 18 for input into a image recognition processor or like device 20, for example, which may apply facial recognition to capture a snapshot 22 of the target person's face from the first (larger) image before extracting it. As known to skilled artisans in face recognition and computer vision generally, the digital stream of the image or image sequence may be parsed for detecting in the datastream various sub-strings which may comply with certain substring characteristics, viz, the characteristics of a human face. Then, computer vision techniques are utilized to “cut out” the face from a possible larger picture. It is understood that the camera device 15 and image processor 20 may be separate devices or embodied as a single stand-alone unit.

In one embodiment, a time of the taking and receipt of the still image/video image may be programmed, and determinable by computer vision, such as at the moment when a person is smiling or when gazing towards the camera device. That is, the image sequence may extract the snapshot of the target person's face 22a when the face in the image is smiling or fully faces the camera. Then, the extracted image 22a is stored in a memory storage system or database 25, comprising non-volatile (or volatile) memory storage media. The extracted image may be stored together with contextual data/meta data such as time, place, camera, and if known that person's “personID”. Finally, according to the invention, the stored image 22a and associated contextual/meta data may be subsequently (or immediately) imported to or retrieved from the same system or second distinct system 30 executing any application requiring visual identification of the person. In one example, for instance, as depicted in FIG. 2, the stored image 22a may be displayed as an icon 22b on a screen display 45 of an electronic system 30, e.g., a mobile telephone 50. Otherwise, the extracted image may be printed on paper in a later processing stage.

According to the invention, the above-described principle may be applied in various camera/computer vision systems:

1) a smart security camera that is adapted to create a logging list of ‘portrait photos’ of people entering or leaving a particular building;

2) a portable “infotaiment” (content used for information or entertainment) players such as the Portable Content Container (PCC) may support use of user icons in an ad-hoc sharing situation;

3) a PC or TV camera could be adapted to use the extracted image to create user icons that could be used to represent a particular person; e.g., representation in virtual community spaces (with advantageously, the feature that the extracted photo is up-to-date);

4) a PC, TV or bathroom mirror display system may be adapted to include an integrated camera that makes a daily snapshot of the person's face. This allows the person to playback a sequence of images of his/her face, to see how his/her face has changed over time;

5) a camera-equipped mobile phone may be used to quickly make a snapshot and to use this picture as a representation of the person's telephone number (caller ID, address book etc). The picture would pop up if this person calls the user's phone, for instance; and

6) a camera at the entrance of a building or a reception may make snapshots of people entering so that these could be used to instantly create a visitor's badge using a camera and computer vision at the entrance/reception of a company building. For example, a ‘face scanning system’ may be employed to continuously scan faces of people entering to see if they are new, or make a snapshot on explicit request. This is especially applicable for an organization requiring user identification badges. That is, this system is useful if badges with photos can be printed instantly and especially when future display technologies become cheap and enable a visitors' badge to be electronically updated with a recent picture of the visitor or employee. This means that an employee badge could (theoretically) be updated every day.

An additional feature may include the employment of the system programmed to frequently capture portrait pictures of a person so that a face recognition system may be kept up-to-date and to gradually adapt the recognition pattern to be able to recognize a person over a long time. For instance, the invention may facilitate and render possible the maintenance of an electronic photo frame of a target user that may be frequently updated (e.g., daily) with a recent picture of the target user.

Those skilled in the art will appreciate that the present invention may be usefully employed in other systems where a facial image may obtained from a first image and subsequently output in a useful form for representation in another system as a separate smaller image.

While there has been shown and described what is considered to be illustrative embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. A system (10) for representing a user in an electronic system (30) comprising:
means (15) for obtaining an image (12) including an image of a target person (22);
means (18,20) for processing said obtained image, said means for recognizing a facial feature associated with said target person (22) in said image and extracting that target person's facial portion (22A) from said image;
means (45) for displaying said extracted target person's facial portion in an electronic system display device to represent that target person's connection to said electronic system (30).

2. The system of claim 1, wherein the means for obtaining an image includes an image capture device such as a camera (15) adapted to generate a still image or full motion image sequence.

3. The system of claim 1, wherein the means for processing includes an image recognition device for receiving a digital stream (18) embodying said image and applying facial recognition technique to extract a target person's facial portion image.

4. The system of claim 2, wherein a time for taking an image from said capture device is determinable at a moment when a target person (22) is smiling or when a target person is gazing towards a image capture device.

5. The system of claim 3, wherein said displaying means utilizes said extracted target person's facial portion (22a) as an icon (22b) for representing said target person via a display interface (45) associated with said electronic system (30).

6. The system of claim 5, wherein said icon (22b) including said extracted target person's facial portion (22a) is immediately or subsequently imported to said electronic system (30).

7. The system of claim 2, further comprising memory storage device (25) for storing said extracted target person's facial portion image (22a), in addition to contextual data associated with said image.

8. The system of claim 6, wherein said contextual data includes meta data including time, place, and image capture device implemented.

9. A method for representing a user in an electronic system (30) comprising the steps of:
a) obtaining an image (12) including an image of a target person (22);
b) processing (20) said obtained image including recognizing a facial feature associated with said target person in said image and extracting that target person's facial portion (22a) from said image; and,
c) displaying (45) said extracted target person's facial portion in an electronic system (30) display device to represent that target person's connection to said electronic system.

10. The method of claim 9, wherein the step a) of obtaining an image includes implementing an image capture device (15) such as a camera adapted to generate a still image or full motion image sequence.

11. The method of claim 9, wherein the processing step b) includes the step of implementing an image recognition device (20) for receiving a digital stream (18) embodying said image and applying facial recognition technique to extract an image corresponding to the target person's facial portion (22a).

12. The method of claim 10, wherein said step a) of obtaining (15) an image includes the step of programming a time for taking an image from said capture device at a moment when a target person (22) is smiling or when a target person is gazing towards a image capture device.

13. The method of claim 11, wherein said displaying step includes utilizing said extracted target person's facial portion (22a) as an icon (22b) for representing said target person via a display interface (45) associated with said electronic system (30).

14. The method of claim 13, further including the step of immediately or subsequently importing said icon (22b) including said extracted target person's facial portion (22a) to said electronic system (30).

15. The method of claim 10, further comprising the step of storing said extracted target person's facial portion image, in addition to contextual data associated with said image, in a memory storage device (25).

16. The method of claim 14, wherein said contextual data includes meta data including time, place, and image capture device implemented.

17. A computer program product for representing a user in an electronic system (30) comprising the steps of:
a) obtaining an image (12) including an image of a target person (22);
b) processing (20) said obtained image including recognizing a facial feature associated with said target person in said image and extracting that target person's facial portion (22a) from said image; and,
c) displaying (45) said extracted target person's facial portion in an electronic system (30) display device to represent that target person's connection to said electronic system.

18. The computer program product of claim 17, wherein the step a) of obtaining an image includes implementing an image capture device (15) such as a camera adapted to generate a still image or full motion image sequence.

19. The computer program product of claim 17, wherein the processing step b) includes the step of implementing an image recognition device (20) for receiving a digital stream (18) embodying said image and applying facial recognition technique to extract an image corresponding to the target person's facial portion (22).

20. The computer program product of claim 18, wherein said step a) of obtaining (15) an image includes the step of programming a time for taking an image from said image capture device at a moment when a target person (22) is smiling or when a target person is gazing towards a image capture device.

21. The computer program product of claim 19, wherein said displaying step includes utilizing said extracted target person's facial portion (22a) as an icon (22b) for representing said target person via a display interface (45) associated with said electronic system (30).

22. The computer program product of claim 21, further including the step of immediately or subsequently importing said icon (22b) including said extracted target person's facial portion (22a) to said electronic system (30).

23. The computer program product of claim 18, further comprising the step of storing said extracted target person's facial portion image, in addition to contextual data associated with said image, in a memory storage device (25).

24. The computer program product of claim 22, wherein said contextual data includes meta data including time, place, and image capture device implemented.
